(19) United States
(12) Patent Application Publication
(10) Pub. No.: US 2019/0182664 A1
(43) Pub. Date: Jun. 13, 2019

(54) Method and device to unambiguously identify a mobile radio communications device

(71) Applicants: Marco Benasedo, Monza (MB) (IT); Paolo Zanco, Grezzago (MI) (IT)

(72) Inventors: Marco Benasedo, Monza (MB) (IT); Paolo Zanco, Grezzago (MI) (IT)

(21) Appl. No.: 16/300,183

(22) PCT Filed: May 2, 2017
(86) PCT No.: PCT/IT2017/000092

§ 371 Date: Nov. 9, 2018

(30) Foreign Application Priority Data
May 12, 2016 (IT) 102016000048621

(51) Int. Cl. H04W 12/00; H04B 17/327

(52) U.S. Cl. CPC H04W 12/00407; H04W 12/00503; H04W 12/00505; H04B 17/327

(57) ABSTRACT

A computerized terminal adapted to authorize or deny opportunities in relation to the authorization level of a person includes a computer associated with a system to unambiguously identify a portable mobile radio communications device when a plurality of the mobile radio communications devices is present, all of which can emit a unique identification radio signal. The system includes a bi-directional antenna to receive the identification signals, a control driver for the antenna to send the signals to the computer, and an electronic card inserted in the computer to process the signals, so to identify the signal of highest intensity received from the antenna and the activation of the authorization or denial of the opportunities for the bearer the mobile radio communications device. A related method enables the unambiguous identification of a portable mobile radio communications device among a plurality of the mobile communications devices present in the same area.

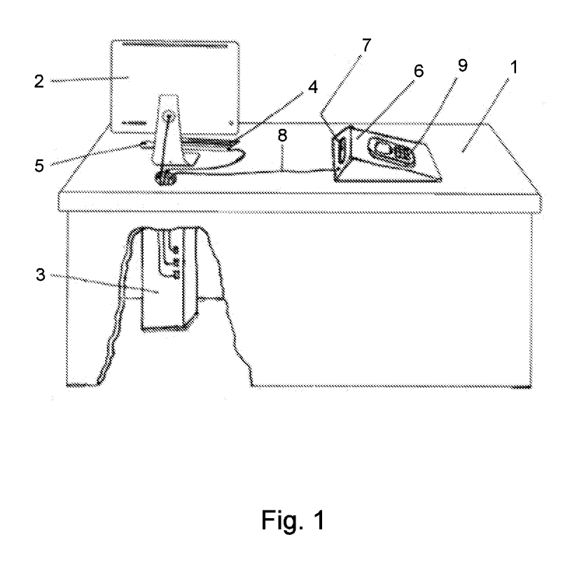

The present invention operates in the field of radio transmissions in a restricted area and, in more detail, the invention relates to a method and a system to unambiguously identify and select a specific portable mobile radio communications device among a plurality of similar devices in the same detection area.

In the present description, with portable mobile radio communications device is intended to identify all those devices, having small dimensions and light weight, that can be carried without difficulty by a user, among which are comprised, without limitation, cellular phones, smartphones, tablets and the like, nowadays widespread among the population.

### STATE OF THE ART

For many years, it is common practice for companies that offer products and services on the market, to secure customers loyalty by offering discounts and other benefits to entice the customer to prefer a particular company with respect to other competitors.

This loyalty is accomplished by registering the customer in a database and normally handing the same a card provided with a bar code, or of another equivalent system, such as a magnetic stripe, which identifies the customer by means of a computer system that reads the above-mentioned barcode or the above-mentioned magnetic stripe.

This set of discounts and benefits has a significant cost for the company that offers the same, but finds its counterpart in the mass of information that the customer leaves, even without knowledge, by using the card, such as: the purchase frequency, buying preferences and the like. All this is well known for which there is no need to dwell further. It must, however, be recognized that, due to the spread of the system and the interest of the customer for these opportunities, a person must carry a large number of cards, at great discomfort.

With time it was found that this practice significantly increases the system cost for the issuing company since the card is often given to relatives and friends, whereas the identity of the bearer is almost never verified; indeed, often, even the manager of the point of sale uses incorrectly her/his own card to facilitate customers who otherwise are not entitled to such benefits. Moreover, the information obtained by the cards are not reliable, since they seem to be from the same person, when in fact belong to different people, with different habits and interests.

There are of course other ways to identify a customer, but are not to be proposed in the field of retail trade. The most widely used at the time is to provide a program (hereinafter “App”) available to customers that the customer can download to her/his mobile radio communications device to communicate directly with the aforementioned Data Base; but it is clear that there is a maximum limit to the number of Apps that a customer can retain at the same time, unless the customer can spend the day uploading and deleting Apps.

Other identification methods may be those that identify a customer by way of reading a fingerprint or the iris of an eye but said systems are extremely expensive, invasive of the customer privacy, and therefore unusable at a normal point of sale (hereinafter “POS”).

Given the above, the Applicants have found a new manner to identify the customer so that the possibility of misidentification of the same substantially decreases and which would exclude the use of cards, Apps, RFID tags, and other similar and well-known devices.

### SUMMARY OF THE INVENTION

The object of the invention is to provide a system for the identification of a person, at extremely high precision, in absolute safety, non-invasive with respect to the sensitive data of the person being identified, of modest cost and great ease of use and product life durability of the assembly.

A first aspect of the invention, therefore, relates to a computerized terminal adapted to authorize or deny certain opportunities in relation to the authorization level owned by the applicant for said opportunities, said terminal comprising a computer associated with a system for unambiguously identify a portable mobile radio communications device in the presence of a plurality of said mobile radio communications devices, each device being provided with the possibility to emit an identification radio signal that unambiguously identifies it, said system being characterized by comprising

a bi-directional antenna, capable of receiving said identification signals;

a control driver for said antenna, for sending said identification signals to said computer;

an electronic card that is inserted in said computer for processing said signals received from said antenna, the identification and the selection of the signal of highest intensity and the activation of the authorization or denial of said opportunities for the bearer of the mobile radio communications device that has emitted said signal of highest intensity.

Preferably, said antenna is associated with a support for said mobile communications devices to minimize the distance between the mobile radio communications device to be identified, and said antenna.

Preferably, said antenna is connected with said computer by means of a data transmission cable.

In a second aspect, the invention also relates to a method to unambiguously identify a portable mobile radio communications device among a plurality of said mobile radio communications devices, each device being provided with the possibility to emit an identification radio signal that unambiguously identifies it, in order to authorize or deny certain opportunities in relation to the authorization level that the bearer of said mobile radio communications device has, said method being implemented by means of a terminal that comprises a computer associated with a system for carrying out said identification, said method being characterized by comprising the following steps:

activating the emission of said identification radio signal from a portable mobile radio communications device;

approaching, as close as possible, said mobile radio communications device to an antenna for receiving said signal;

sending all the signals received from said antenna to said computer;

processing said signals, by selecting the signal of highest intensity among those received and activate the authorization or denial of said opportunities to the bearer of said mobile radio communications device.

Preferably, the intensity of the selected signal is comprised between −50 dB (decibels) and −7 dB.

### DESCRIPTION OF THE INVENTION

However, the present invention can be better understood from the following description and with the aid of the attached FIGURE, provided solely for example of and not limiting purposes, since other embodiments are however possible, in respect and within the scope of the definition of the objects of the invention according to the claims that follow.

In describing the invention, for convenience of description and ease of understanding, it is assumed as a reference for the computerized terminal a POS, that is, a normal cash point (Point Of Sale) of a generic shop and as a reference for the mobile radio communications device a portable telephone, from now on a cell phone, and precisely that of a customer about to pay her/his purchases using the benefits that have been granted by the seller. However, it is clear that the invention is applicable to any similar system, thinking for example of a people identification station as well as to a different telephone device.

The invention stems from the intuition of the Applicants that a person can easily give her/his card to a third party, but would never hand over her/his cell phone to others. This, in fact, in addition to serving to communicate remotely with others at unpredictable moments, in any case, contains an amount of personal data that each person intends to keep confidential.

Based on this insight, the Applicants have perceived that a customer could be identified by identifying her/his cell phone because it can be assumed with reasonable certainty that the cell phone bearer is actually the owner of the same.

Furthermore, the Applicants have perceived that the identification of the cell phone could be done by using its MAC address according to the Bluetooth technology. The MAC address is an exclusive code that identifies the Bluetooth card inserted in the cell phone.

The exclusiveness is guaranteed by the Bluetooth card producers. This exclusiveness can be used to identify the device carrying the card and possibly to associate the device to a card with more information. This insight has allowed to use the system according to the invention for all uses that to date are conferred to a card, to a RFID tag or to an APP installed on a device that contains a Bluetooth or wireless card.

The detection of mobile radio communications devices in a specific area turns out to be a very widespread practice in recent years for a significant amount of uses. This detection allows to exchange information between two devices and especially to know if a particular device is in a particular place and for how long it was there.

However, for the purposes of the invention, the distance between the devices and the extent of the area in which they are found has proven to be a crucial element. In fact to select a specific device among all those present in a restricted area, that of the POS in question, is the purpose.

The Applicants have realized that the Bluetooth system was the most interesting as, having a limited range, lent itself well to detecting devices present in the vicinity of POS. The necessity was then felt to identify which among these was the device to be examined.

Always according to the invention, the Applicants have realized the need to have an antenna capable of detecting all the devices present in its range of action, in order to determine which of these was the interested device.

After verifying that the signal strength emitted by the identified devices was too variable to identify with certainty the device to be identified, as depending on the type of device, on its size and on the materials with which it was made, the Applicants have realized that the decisive element for the identification was the distance of the device from the antenna.

Indeed, the difference in strength received by the antenna between that of a device that is at 3 cm distance and that at a distance of 30 cm is evident, whereas the difference between two devices placed one at 1 m and one at 1.3 m from the antenna is practically equal to zero. The Applicants were able to conclude that, in order to be identified, the cell phone had to be brought as close as possible to the antenna.

In order to facilitate the set of operations required to the customer, the Applicants propose, then, to provide a support in which the antenna can be housed and on which to lay the cell phone so as to place it very close to the same, which is practically never more than 3 cm.

For the transmission of the MAC address from the cell phone to the antenna the Applicants, according to the invention, have chosen the RSSI value (Received signal strength indication) which provides an accurate value when the two devices are very close (almost in contact) and values gradually decreasing as moving away from the antenna.

However, the RSSI is the result of a complex calculation that most of the known antennas are unable to calculate. The Applicants have realized that the problem could be solved by combining a specific antenna with a specific driver and with a specific control software. The combination was that of an antenna capable of receiving an RSSI signal coupled to a driver capable of controlling the selected antenna. Only after defining this combination, the Applicants have been able to develop a decoding software of the signals received able to manage the potential of the selected antenna and driver combination.

By using the RSSI value combined with the detection of the signal strength, the Applicants have finally been able to identify the MAC address of the cell phone near the antenna located between the MAC addresses of cell phones in the vicinity, defining the intensity value of the signal to be identified between −50 dB and −7 dB and performing all measurements and calculations required in only 3 seconds within the cell phone was in the vicinity of the antenna. Even more preferably, the above signal intensity is chosen between −30 dB and −10 dB.

For values less than the lower limit the signal comes from devices too far away from the antenna, for values above the higher limit the signal is not reliable and is caused by one or more interference sources.

The attached FIGURE illustrates the terminal according to the invention in a preferred embodiment, albeit schematic.

The FIGURE illustrates a normal POS, that is, a point of sale, or better the cash area of a normal shop.

The area comprises, in a per se known manner, a desk 1 on which the customer lays the purchased goods to allow for accounting. On the desk a monitor 2 connected with a computer 3, a keyboard 4, a mouse 5, preferably of wireless type and not illustrated, the device for the reading of the credit cards and the cash printer are provided.

All the software needed for managing the point of sale and for the identification of registered customers is usually housed inside the computer. In fact, the computer also contains a database, or is connected with a server containing said database which contains profiles of all the customers cards registered at the company owning the point of sale. As such, said customers are entailed to stated authorizations or may enjoy certain benefits. The assembly of all these devices is more simply defined here as “terminal”.

According to the invention, on the desk a bluetooth bidirectional antenna 7 is also provided, whereas in the computer a hardware card and a control driver for the management of the aforementioned bidirectional antenna are also housed. Alternatively, the aforementioned card is directly associated with the antenna and in said case is connected to the computer by means of a data transmission cable 8. In order to facilitate the customer, whose hands are engaged in payment transactions, the terminal may provide a support 6, on which the cell phone can be laid during the customer identification step. In this case, the antenna is inserted in said support so as to maintain the distance between the cell phone and the antenna no more than 3 cm.

The terminal according to the invention is characterized in that said antenna is capable of receiving the RSSI signals, and in that said driver is capable of driving said antenna.

The antenna can be located at any convenient point, above the desk as well as below the same, but, preferably, for protective purposes, the antenna can be housed in the support 6 and even more preferably, it may even be embedded in a specific material which can also form the support 6 itself.

As mentioned previously, the customer who enjoys certain trade benefits, as being previously registered at the POS, activates the MAC address emission from her/his device (cell phone 9), then approaches the antenna with the device and eventually lays the latter on the support; the MAC address emitted from the cell phone is identified by the antenna along with those emitted by the plurality of mobile radio communications devices (those of other customers waiting) in the cash area, and all are sent to the computer.

In said computer an electronic card is inserted which decodes said signals making them readable by the software which unambiguously identifies, due to the greater intensity, the signal received from the cell phone nearer to the antenna than the others, and thus authorizes or denies the use of the benefits provided in relation to the authorization level that the customer has.

From what has been described it is evident that the invention also provides a method for unambiguously identify a portable mobile radio communications device among a plurality of said mobile radio communications devices, as long as each device is provided with the possibility to emit an identification signal that unambiguously identifies it, in order to authorize or deny certain opportunities in relation to the authorization level that the bearer of said mobile radio communications device has. The method is implemented by means of a terminal that comprises a computer associated with a system for carrying out the aforementioned identification, and comprises, according to the invention, the steps of activating the emission of said identification signal from a portable mobile radio communications device, bring said mobile radio communications device close to an antenna for receiving said signal, sending said signal to said computer, perform the identification of said signal and process said signal to activate the authorization or denial of the above opportunities to the bearer of said mobile radio communications device.

Preferably, the identification signal is the MAC address of the mobile radio communications device to be identified and the transmission of said signal between the mobile radio communications device and the antenna is done by means of a Bluetooth card.

Preferably, the intensity of the signal processed by the computer is selected between −50 dB and −7 dB, and even more preferably, between −30 dB and −10 dB.

The disclosed invention offers important advantages.

Above all, it allows to identify the user of a device without the user having to show an instrument or an object (e.g. a RFID card or tag) or a software to be downloaded on her/his device (e.g. an App) to be identified. The customer, instead of having to provide a plurality of cards, one for each commercial store, or having to download on her/his device a plurality of Apps, uses always the usual identification code, the MAC address of her/his device.

The possible applications of the invention are countless; thinking, for example, to open a room in a hotel, or enter into a protected area, as well as activating a vehicle, a burglar alarm, or a timecard puncher (all without the need to download a specialized App).

Secondly, the invention provides the guarantee that the code read is that of the device facing the antenna, in fact, if the device does not approach the antenna it is impossible to obtain its code.

The confidentiality of the customer privacy data is also ensured as the operator receiving the MAC address cannot replicate the device code in any way, therefore fraudulent behavior, like copying a bar code or a magnetic stripe, are avoided. In fact, the software that physically acts on the antenna and reads the message sent by the device does not reveal it, but answers if the device found (the MAC address is associated with the personal data sheet of the holder) is in the data base, without disclosing the identity of the MAC address code to the operator.

According to the method, the customer must perform a maneuver to make his cell phone available to be identified, otherwise the same will always be invisible. This maneuver, that is, moving the cell phone near the antenna together with making visible the cell phone Bluetooth signal, fits perfectly the need for the customer to make “a movement” in order to be identified, resulting in accepting the system and therefore compliance with the privacy laws.

Finally, the identification method according to the invention is absolutely respectful of the customer pausing time at the terminal, and therefore of the waiting time of the customers that follow, as it performs all the detections and the calculations necessary in a time not exceeding 5 seconds, but normally implemented in only 3 seconds while the cell phone rests on the support.

In the present description all the possible structural and dimensional alternatives to the embodiments of the invention specifically described have not been normally illustrated; in fact, it did not seem necessary to expand in construction details of the inventive system as each technician skilled in the art, following the instructions given here, will have no difficulty in designing, by choosing appropriate materials and sizes, the most advantageous technical solution. These alternatives, however, are intended to be comprised within the scope of protection of the present patent, said alternative embodiments being per se easily derivable from the description of the relationship that links each embodiment with the result herein provided, that the invention wishes to obtain.

We claim:

1. A computerized terminal adapted to unambiguously identify a portable mobile radio communications device when a plurality of said mobile radio communications devices are present, each radio communications device being configured to emit an identification signal that unambiguously identifies said radio communications device, said terminal comprising:
a computer associated with:
a bi-directional antenna, configured to receive said identification signals;
a control driver for said antenna, to send said identification signals to said computer; and
an electronic card that is inserted in said computer to process said identification signals received from said antenna,
wherein electronic card selects the identification signal of highest intensity within an intensity range comprised between −50 dB and −7 dB.

2. The computerized terminal according to claim 1, wherein said antenna is configured to receive signals adapted to determine an RSSI value.

3. The computerized terminal according to claim 1, wherein said driver is configured to drive said antenna.

4. The computerized terminal according to claim 1, wherein said card is associated with the antenna and is connected to the computer with a data transmission cable.

5. The computerized terminal according to claim 1, further comprising a support for laying said mobile radio communications device during identification of said device.

6. The computerized terminal according to claim 5, wherein said antenna is housed in said support and keeps a distance between said mobile radio communications device and said antenna by no more than 3 cm.

7. A method for unambiguously identifying a portable mobile radio communications device among a plurality of mobile radio communications devices, each radio communications device being configured to emit an identification radio signal that unambiguously identifies said radio communications device, said method being implemented with a terminal that comprises a computer associated with a system that carries out identification, said method comprising the following steps:
receiving, through said computer, said identification radio signals emitted from said plurality of portable mobile radio communications devices;
performing the identification of a signal of highest intensity between all received signals and processing said signal to identify the radio communications device which has emitted said signal of highest intensity; and
selecting the signal of highest intensity having an intensity comprised between −50 dB and −7 dB.

8. The method according to claim 7, wherein said identification radio signal is an MAC address code.

9. The method according to claim 7, wherein said signal is received by way of a Bluetooth transmission.

10. The method according to claim 7, wherein selecting the signal of highest intensity comprises selecting the signal of highest intensity within a range between −30 dB and −10 dB.
